(19) United States
(12) Patent Application Publication
(10) Pub. No.: US 2010/0070383 A1
(43) Pub. Date: Mar. 18, 2010

(54) METHOD AND DEVICE FOR AUTOMATED PROCESSING OF GOODS DATA

(76) Inventor: Sandro Kunz, Mantel (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/561,380

(22) Filed: Sep. 17, 2009

Related U.S. Application Data
(60) Provisional application No. 61/098,020, filed on Sep. 18, 2008.

(30) Foreign Application Priority Data
Sep. 18, 2008 (DE) 10 2008 042 193.6

(51) Int. Cl. G06Q 30/00; G06Q 10/00; G06F 17/30

(52) U.S. Cl. 705/27; 705/343; 707/803; 707/705; 707/E17.005; 707/802; 707/E17.001

(57) ABSTRACT

The present invention relates to a method or a device for automated processing of goods data for sales purposes as well as for automated processing of goods data for the manufacture of printed goods presentations, in which data for online publications and/or online sales offers and/or data for an ERP system are used simultaneously for the purpose of creating printed goods presentations in the form of catalogs, brochures, advertising flyers and the like.

### CROSS-REFERENCE TO RELATED APPLICATIONS

This application claims priority to U.S. Provisional Application No. 61/098,020 filed on Sep. 18, 2008 and German Application No. 10 2008 042 193.6 filed on Sep. 18, 2008, the entire contents of each of which are incorporated herein by reference.

### FIELD OF THE INVENTION

The present invention relates to a method for automated processing of goods data for sales purposes or for the manufacture of printed goods presentations in the form of catalogs, brochures and the like and corresponding devices for this.

### BACKGROUND OF THE INVENTION

So-called internet trading, i.e., trading in which goods can be offered over the internet and acquired over the internet by a buyer via corresponding communications, is growing steadily. In addition to a plurality of so-called online shops, which offer their goods via internet pages and ship the goods to the customers after it has been ordered, other internet-specific sales forms, such as internet auctions and the like, have become established. Accordingly, there are so-called internet portals or general internet pages on which pricing information and sets of goods are published that enable the user to gain a simple overview of the range of goods and to make their selection directly. Generally, these can be regarded as internet marketplaces in which all kinds of distribution of goods and services can be effected via the worldwide computer network that is the internet.

To operate an online shop or to post offerings for sale in an internet auction, it may be necessary to create digital photos of the item for sale, and to compile and upload a description of the offerings to an appropriate server on the internet or computer network in general, such that the offerings are visible to users on the relevant pages in the network. Furthermore, it may be necessary to monitor whether certain order processes, for example via e-mail and the like, are received in order that processing of the order can be initiated. In addition, payments must be processed and, especially, receipt of payment monitored, in order, for example, that the shipping process for the goods in question may be initiated on receipt of payment. This is very time consuming and not lucrative for products with low profit margins. For this reason, technical solutions to automate the bulk of these operations have been created. One such technical solution is the method underpinning the “Speed4Trade” (Trademark) software program, which facilitates the posting of sales items in different internet distribution channels and automates the entire sales process.

The sales system does this by using data stored in an ERP (enterprise resource planning) system for managing inventory. This greatly reduces the effort required for entering the data needed for preparing the sales offer, as much of the required data is already in the ERP system. Overall, the Speed4Trade solution can make for a time- and cost-efficient internet trading operation, since the work processes for posting a plurality of sales offers to all kinds of internet sales channels are largely automated. As a result, it is also possible to successfully sell goods with a low profit margin over the internet.

Although this in itself yields very great labor and cost savings and thus constitutes a high degree of automation, there is a further need to further increase the efficiency of such sales processes and sales channels and to attain a high degree of automation and extensive functional integration into automated methods and equipment overall.

### DISCLOSURE OF THE INVENTION

An aspect of an embodiment of the present invention is characterized by the fact that further automation is possible to the extent that the existing data from an ERP system and/or existing data for an online publication or posting of an online sales offer to a computer network can be used to automatically create printed goods presentations, such as catalogs, brochures and the like, without the need for additional time-consuming and labor-intensive collation of the data to be published, such as images, text, descriptions and the like. Instead, the existing data from the ERP system and/or internet trading are used and these existing data are processed in an automated method to yield a print template for a printed goods presentation. Thus, the user is given a technical tool with which, by simply selecting certain goods or goods groups and corresponding setting variables for the printed goods presentation, one can create a printed goods presentation efficiently that, in addition to internet sales offers and online publications, one can distribute and/or can send to selected customers. This also creates the possibility of customized advertising with printed publications, which can be targeted at certain groups of customers, for example in terms of language, place of residence, buying habits, or tailored to certain sales offers, for example, in one or more selected online sales channels and the like.

An embodiment of the present invention is therefore characterized from a first aspect in that, in a method for automated processing of goods data for sales purposes, a database of goods data is provided which comprises goods information for managing inventory and/or data for describing the goods. The database can therefore use either only pre-existing data from an ERP system, for example, on sales prices, dimensions, weight and the like, to create the print template or, alternatively or additionally, further data for describing the goods, with the data already being held in a database for online shops or internet platforms. Alternatively, it is also conceivable for additional data for describing the goods to be collected in a database.

Furthermore, a further aspect of the invention provides a processing module, which prepares the goods data for publication, with the processing module collaborating with a database or a storage memory of layout information, such that a print template for a printed goods presentation is generated automatically from the goods data at the request of the user. Such a method can be implemented programmatically by means of a data processing system which has access to a database of goods data. The database of goods data can, in this connection, also be stored in the data processing system directly or remotely on a corresponding server or central computer, in which case suitable communication methods for establishing a data connection are provided. The same applies to the databases of layout information, the purpose of which is to enable incorporation of the goods data into a print template for a printed goods presentation.

The database of goods data, as has already been mentioned, can comprise goods information for inventory management, of the kind stored in an ERP system, and additionally those data for describing the goods which have been compiled specifically for marketing purposes, such as image files, descriptive texts in one or more languages, technical data, etc. The corresponding data, such as the goods data for the inventory management, can be transferred from existing databases and databases already used by other systems or be incorporated by reference into the corresponding databases of goods data. Thus, existing structures of an ERP system which comprise data for handling goods data in a commercial company, and/or data for on-line distribution, can be used in connection with this invention.

Consequently, the database of goods data can comprise a self-contained database of uniform data structure, or several sub-databases, which are interlinked and collaborate with each other.

Accordingly, the processing module can either merely prepare data from an ERP system for publication for a printed goods presentation in the form of a print template or additionally use created or existing data for describing the goods to create a print template for a printed presentation.

The processing module can additionally use the existing goods data, i.e., goods information and data for describing the goods, to additionally generate online sales offers, internet presentations and the like or to employ the data existing for these intended uses for printed publications as well.

According to a second aspect of the present invention, a method or a device for the manufacture of printed goods presentations in the form of catalogs, brochures and the like in which layout information for the design of the printed goods presentation is provided and wherein, by means of a processing module, a print template for the printed goods presentation is generated automatically in accordance with the layout information, wherein the goods data are taken from a database used for creating online publications, such that the data already used for the goods presentation in online shops and internet auctions and the like can additionally be used for printed goods presentations in the form of catalogs, brochures and the like, wherein the generation of the printed goods presentation or the corresponding print template is largely automated. This brings a significant gain in efficiency, since the previous approach to printed publications entailed a considerable outlay for collating the goods data, designing the goods presentation and generating a corresponding print template. Additionally, duplicate work was often performed that the inventive method can eliminate. Thus, the user is provided with a technical tool which, owing to the high level of integrated automation, enables efficient use to be made of data.

An inventive device can therefore have a corresponding data-processing system with a database or a storage memory of layout information for the design of the printed goods presentation as well as a processing module implemented in the data processing system in the form of software, with the processing system configured such that the goods to be presented in the printed goods presentation are automatically collated in a print template, wherein the processing module has an interface for extracting the goods data from a database of goods data used for generating online publications. The database of goods data can be stored in the same data-processing system or in a different data-processing system, such as a central server and the like, such that the interface in certain circumstances comprises corresponding communication methods for data exchange.

The database of goods data may, in turn, merely comprise data for describing the goods for the online publication or additionally goods information from an ERP system. Accordingly, several sub-databases interconnected can be provided, or a self-contained database with a self-contained data structure may exist.

The layout information can in turn be stored in a database, which is stored separately or together with the database of goods data or wherein the database of layout information is integrated into the database of goods data.

The database of layout information can contain all kinds of information for designing the printed goods presentation, such as information about the text size, text position, image size, image position, font, font color, background color, frame layout, page size, number of pages and pagination, etc.

In line with the layout information, the processing module can provide a layout framework which is then automatically populated with the corresponding goods data from the database.

The processing module can furthermore provide an input unit which enables a user to select the goods or groups of goods for inclusion in the printed goods presentation or to decide when or in what cycles the printed goods presentation should be created automatically and/or which layout should be used.

It is also possible to specify which groups of customers, for example, customers in a particular country, customers with particular interests, customers with specific shopping behavior, etc., should be offered customized and appropriately modified printed goods presentations. In this connection, customization can range from being very extensive to including just a few or even individual printed goods presentations. Moreover, it is also possible to generate goods-related printed material, for example, thematic presentations or printed products tailored to the special offerings of a sales channel. With these few items of information or selection for determining the printed goods presentation, the laborious and complex process of producing a printed goods presentation can be performed fully automatically, such that all steps from the provision of corresponding images and descriptive texts through to integration of this information into corresponding print templates can all proceed automatically.

In a data-processing device, such as a PC and the like, the data-processing module can collaborate with input devices, such as keyboards and the like, for the purpose of realizing an input unit.

Depending on how much information is available to the system as a whole, various measures can be taken. For example, where sales information, such as information about items purchased by a user, as well as customer address information and the like are available, it is possible, on the basis of the items sold and the interests of the customer, to include tailored goods offers in a printed goods presentation and to send them specifically to the customer. For example, it is possible to log the other products bought by purchasers of a certain product, such that corresponding goods groups can be formed, which can then also be included in a corresponding printed goods presentation.

In this connection, highly customized print templates, ultimately tailored to the individual addressee of the printed goods presentation, can be created because modern digital printing technology makes it possible to produce printed material cost-efficiently, even in the smallest print runs.

To this end, the print template can be provided as a data file, for example in the widely used PDF (portable document format) format, that can be processed by the printing device.

The level of automation can extend as far as the processing module's sending the produced print template automatically to a printing device, which can be located either in the vicinity of the data-processing system or to which the print data are supplied via a remote data connection. As a result, without further action by the user, the printing process can be automatically started, there being an additional possibility of, for example, shipping the printed goods presentation to the addressee immediately after printing in the event that the address information is printed.

In addition, it is also possible for the print template, such as a PDF file, to be sent direct to corresponding addressees via e-mail, such that the addressees themselves can print out the printed goods presentation. Such a file can, in turn, contain corresponding hyperlinks to the online shops, such that, after the user has read the printed information, for example, the user can very simply order the selected goods online by using the hyperlinks contained in the file to immediately gain access to the corresponding internet offering.

### BRIEF DESCRIPTION OF THE FIGURES

FIG. 1 illustrates a schematic diagram of an embodiment of the present invention for the automated processing of goods data for sales purposes and for the production of printed goods presentations in the form of catalogs, brochures and the like.

FIG. 2 illustrates a database structure and the relationship between the information in the database and the printed goods presentation.

FIG. 3 illustrates a schematic diagram of the collaboration between various devices involved in an embodiment of the present invention for the automated processing of goods data for sales purposes and for the production of printed goods presentations in the form of catalogs, brochures and the like.

FIG. 4 illustrates a description of how the processing module functions.

### EMBODIMENTS

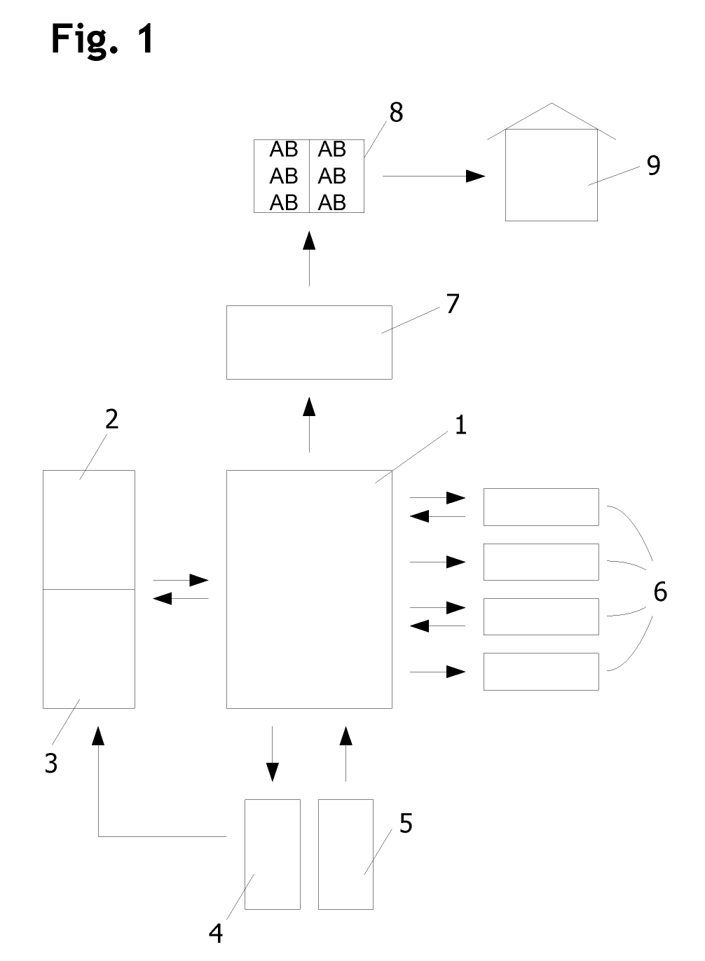

For purposes of description herein, the terms “upper,” “lower,” “right,” “left,” “rear,” “front,” “vertical,” “horizontal,” “top,” “bottom,” and derivatives thereof shall relate to the invention as viewed in FIG. 1. However, it is to be understood that the invention may assume various alternative orientations, except where expressly specified to the contrary. It is also to be understood that the specific device illustrated in the attached drawings and described in the following specification is simply an exemplary embodiment of the inventive concepts defined in the appended claims. Hence, specific dimensions, proportions, and other physical characteristics relating to the embodiment disclosed herein are not to be considered as limiting, unless the claims expressly state otherwise.

FIG. 1 shows a schematic diagram of a system for automated processing of goods data for sales purposes or for manufacturing printed goods presentations in the form of catalogs, brochures and the like in accordance with an embodiment of the present invention, wherein the system comprises embodiments of the corresponding devices, databases and software products and works in accordance with the illustrated method.

FIG. 1 shows a processing module 1 as a central component, which can be formed as a software product for execution on a data-processing device. The processing module 1 collaborates with a database 2, 3, which, for the present embodiment in FIG. 1, is shown in two parts. However, the database 2, 3, can also have a self-contained database structure and thus be viewed as one part.

The database 2, 3 comprises a sub-database 2 of goods information for the purpose of inventory management of the kind used in a well-known ERP system. Such an ERP system comprises, for example, data on a plurality of different goods A1, A2, A3 . . . AN, which are stored in the database of the ERP system. The goods information comprises, for example, goods numbers, information about the amount of goods in stock, the storage location, the purchase price, the sales price, the dimensions, the weight, etc. Altogether, the sub-database 2 of the ERP system stores all the information needed for trading in the corresponding goods and handling the goods, e.g., shipping and the like. Such ERP systems generally find widespread use not just in the retail trade but also in production plants or in industry as they facilitate material flow and logistics, as well as enterprise planning.

In accordance with the illustrated embodiment, a further sub-database 3 of marketing information or data for describing the goods is provided, in which data on the individual items of goods are stored that can be used for descriptions in a sales brochure and the like. Accordingly, the sub-database part 3 can comprise data for describing the goods, such as image data on the different products, text data, etc.

As shown in the embodiment of FIG. 1, the sub-database 3 is provided as an additional separate database in addition to the sub-database 2 of the ERP system. Accordingly in this design, there are two independent databases, which the processing module 1 can access for the purpose of retrieving the required information.

Alternatively, simply one database into which the sub-databases 2 and 3 are integrated may be provided. Such a consistent, central database of goods data can also be generated in a simple manner by exporting an already existing database for an existing ERP system and/or a database of data for describing the goods into the database of goods data.

The data for describing the goods, which are contained in the multi-part database of goods data or in the one-part, integrated database of goods data, are processed by the processing module 1, such that they can be automatically posted to corresponding online shops, internet auction platforms, general internet platforms, internet browsers and the like for the purpose of posting the sales offer. The corresponding on-line internet offerings 6 can, in this regard, be of a varied and diverse nature and, especially, several of these on-line internet offerings 6 can be realized by the processing module 1.

The posting of a corresponding goods offer to online internet shops, internet platforms and the like is done automatically by the processing module 1, such that the bulk or all workflows for posting the offering or publication/promotion are performed automatically, such that the user of the corresponding system does not have to execute or instigate the working steps individually by hand, but rather the entire workflow or at least large parts thereof are performed independently of user input.

The user need only make a selection as to which goods are to be posted in which on-line publications via an input unit (not shown) of the processing module 1. But here, too, the processing module 1 affords a high degree of automation, more precisely to the extent that, in accordance with certain specifications, such as time constraints, it is possible to post new offerings automatically. It is also possible where certain goods are being sold off in individual online shops or auction platforms to post new offerings related to the sold-off goods. This can be fully automated.

Accordingly, at least partly in the case of certain online offerings, not only can information about goods offers be uploaded to the corresponding internet platform or online shop, but sales information or orders can also be read out, as indicated by the double arrows between the processing module 1 and the online offerings 6.

Accordingly, the processing module 1, in line with a received order, can issue a command for the shipment of ordered goods to a delivery module 4, for example a computer providing corresponding work instructions for shipping employees. Additionally, a payment module can be used to determine whether corresponding payments have been received in order that corresponding shipping processes may be triggered only after receipt of payment. Similarly, data can be exchanged with the sub-databases 2, 3 directly via the processing module 1 or via the shipping module 4 in order that the ERP system may be kept up to date. For example, when goods are sold, the number of goods in stock needs to be adjusted accordingly.

In accordance with the illustrated embodiment, however, the processing module 1 uses the data for describing the goods that are already in the sub-database 2, 3 not only for automated posting of offerings or promotional information to the internet, but also permits a print template for a printed goods presentation to be generated automatically. This is shown in FIG. 1 by the arrow between the processing module 1 and a printing device 7. This can be a major simplification of workflows in a company, since for the first time an integrated solution for managing goods in an ERP exists which facilitates the simultaneous use of the data from the ERP system, possibly supported by additional descriptive data, for online marketing and marketing with printed publications. It is therefore no longer necessary to perform separate data logging for marketing campaigns with printed publications, but rather resort can simply be made to the data already in the ERP system and for the on-line publication.

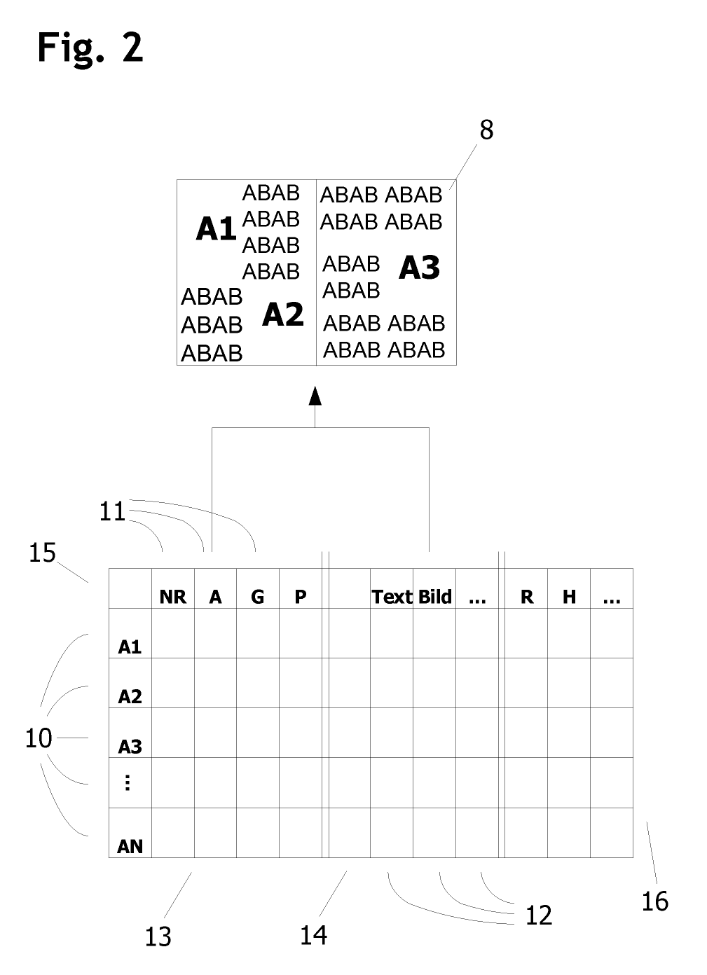

FIG. 2 is a purely schematic illustration of a possible structure of a database 15 that can be used for the sub-databases 2, 3 of the embodiment of FIG. 1.

The database 15 has a plurality of data fields, which in accordance with FIG. 2, are divided into a plurality of rows 10 and columns 11, 12.

The rows 10 contain the data for the individual items of goods A1, A2, A3 . . . AN, while the columns 11, 12 define the type of data stored in the corresponding fields. For example, a sequential goods number may be provided in the first column, the number of items of goods in stock in the next columns, and then information on weight, price and the like. These data, which are stored in the columns 11 for goods A1 to AN, correspond, for example, to the goods information for managing inventory in an ERP system. Similarly, that section of the database containing columns 11 which is marked by the double line separating columns 11 and 12 is viewed as the ERP section 13 of the database 15. Columns 12 of the database 15 can store data for describing the goods, such as texts, images and the like, such that this section of the database 15 can be described as a goods description section 14.

The corresponding information for inclusion in a printed goods presentation 8, such as dimensions A, price P, images, descriptive texts, are then retrieved from the database 15 and collated, in accordance with layout information, such as background colors, frame layouts R, etc., to yield a corresponding print template for the printed presentation 8.

As shown in FIG. 2, the layout information in the database can be provided in a corresponding layout information section 16.

A corresponding print template for the printed presentation 8 can, in accordance with the illustration of FIG. 1, be transmitted to the printing device 7, which processes the print template directly to the printed presentation 8.

Since the sub-databases 2, 3 or the database 15 can additionally contain address information about the addressees of the printed presentation 8, the printed presentation 8 can be sent direct to addressees 9, since, for example, the corresponding address data can already be printed direct on the printed goods presentation 8.

The sub-databases 2, 3 or the database 15 can also contain a wide range of information that can be used for marketing or sales purposes. Thus, the database can contain information about goods combinations that, for example, have already been bought by customers or are thematically related. Similarly, thematically related printed goods presentations can easily be created, because corresponding information in the database facilitates easy data selection. Overall, it is thus possible to create wholly customized printed goods presentations, which, depending on the addressee, include only those goods which are related to goods already sold to the addressee. In this way, the effectiveness of a printed goods presentation can be markedly increased, as there is a greater probability that the printed goods presentation includes only goods which are of benefit or interest to the addressee. Customized printing of individual copies is possible without much effort, on account of digital printing, with the data files serving as print template.

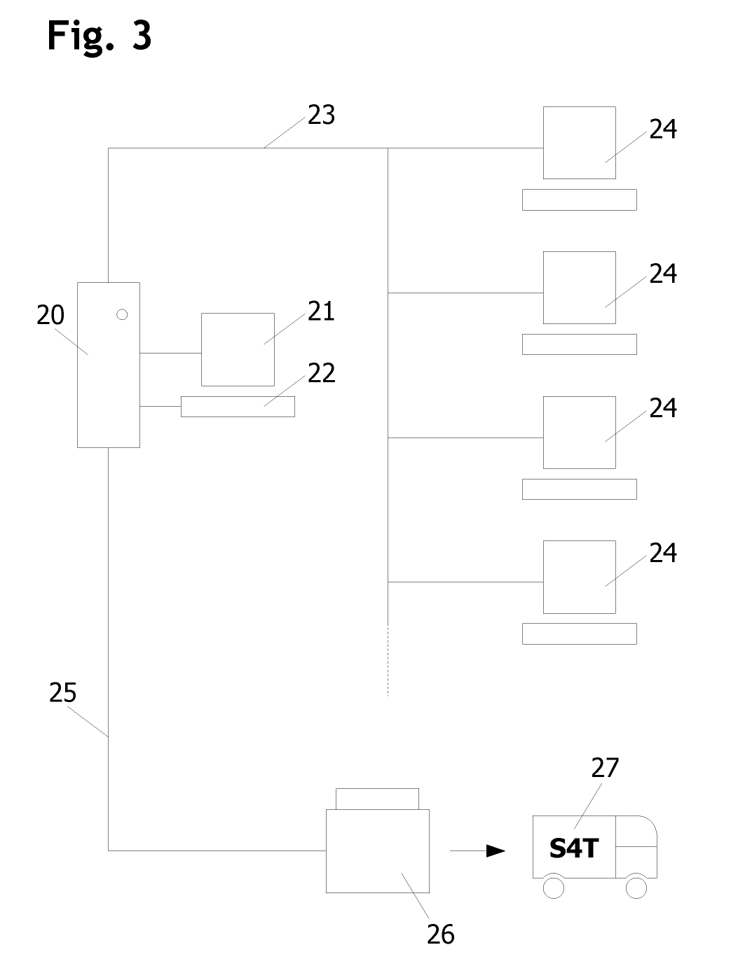

FIG. 3 shows collaboration among the various devices of a corresponding inventive system, which operates according to the illustrated method.

FIG. 3 shows a data-processing system 20, such as a personal computer or PC. The data-processing system 20 has input devices 22, such as a keyboard, and output devices 21, such as a display.

The software product whose command sequences facilitate execution of the illustrated method during implementation is stored in corresponding memory inside the data-processing system 20. Connected to the data-processing system 20 via a data connection 25 in the form of a line or a wireless connection is a printing device 26, which processes the print template in the form of a data file created by the data-processing system 20. The corresponding printed goods presentations can be distributed direct from the printing device 26 to the relevant addressees by means of delivery services 27.

The data processing system 20 is furthermore connected to a plurality of network stations 24 via communication lines 23, such as are connected together in a network via the internet. The online publications or online offerings generated by the processing module or the data-processing system 20 are uploaded to the server via the communication lines 23, where they can be seen and availed of by all internet users. The orders can then be sent back to the data-processing system 20 direct via the network stations 24 or servers of the various online shops, internet auction platforms or other internes platforms, with the processing module performing corresponding processing and, for example, monitoring payment receipts, instigating shipping of ordered and paid goods and updating the ERP system accordingly.

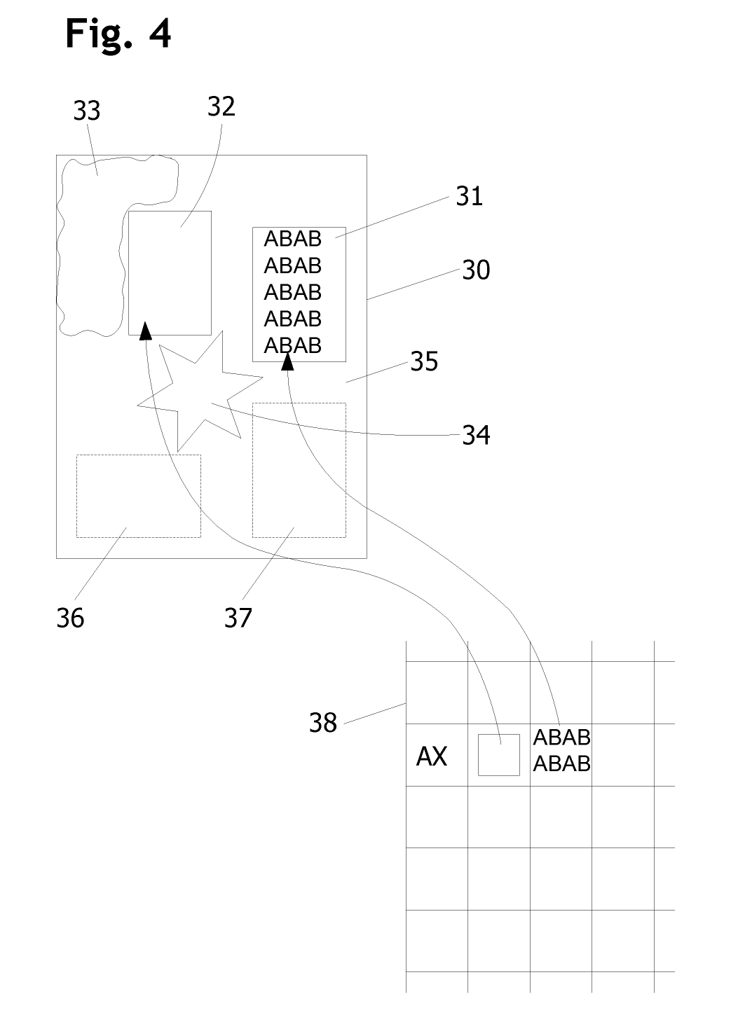

FIG. 4 shows how the processing module uses the goods data from a database 38 to create a print template for a printed presentation. The printed presentation shown as an example is a promotional flyer or page 30 of a catalogue. The background color or the design of the background 35, for example, is preset in accordance with the layout information. In the same way, the layout information can specify design elements, such as a star 34 or a frame element 33. In corresponding place holders for text 31 or for an image 32, the corresponding image data or text data are retrieved from the database 38 and inserted into place holders 31, 32. Further place holders can be found on page 30, for example in the area indicated by the dotted frames 36 and 37.

In accordance with the goods specified for inclusion in the printed goods presentation and with the selected layout, the processing module can automatically determine the scope of the printed goods presentation and the requisite size of each place holder 31, 32, 36, 37.

The illustrated invention thus makes it possible not only to make a direct connection to on-line purchasing platforms, such as online shops, internet auction platforms and the like, with an electronic, digital ERP system in an efficient way, but also to conduct paper-based marketing campaigns, such as the shipping of printed catalogs, brochures, advertising flyers, etc., in a simple way, without the need for additional and laborious data entry. In addition, highly customized, personalized printed goods presentations can thus be created.

Although the present invention has been described in detail using the disclosed embodiments, it is clear to a person skilled in the art that the invention is not restricted to these embodiments, but that modifications and amendments, especially those arising from the exclusion of certain features or other combinations of the presented features are possible, without the scope of protection of the enclosed claims being exceeded. The invention specifically includes any combination of the features presented. Accordingly, the present invention comprises especially the following features:

A method for the automated processing of goods data for sales purposes comprising:

provision of a database of goods data comprising goods information for managing inventory and/or data for describing goods, provision of a processing module which prepares the goods data for publication, characterized by the fact that a database of layout information is made available, such that, on request, the processing module automatically uses the goods data to create a print template for a printed goods presentation.

A method as set forth in the previous paragraph, characterized by the fact that the goods information for managing inventory is taken over from a database of goods information and/or data for describing goods are taken over into the database of goods data or are incorporated into this by reference.

A method as set forth in the previous two paragraphs, characterized by the fact that the database of goods data is a database having a self-contained data structure or comprises several sub-databases.

A method as set forth in the previous three paragraphs, characterized by the fact that an existing database of goods information for managing inventory is used, said database being managed and/or shared by other systems, and/or the data for describing goods, which are managed and/or shared by other systems, are used.

A method as set forth in the previous four paragraphs, characterized by the fact that the processing module automatically prepares and/or provides the goods data additionally for the purpose of publication in at least one of the group comprising online shops, internet auction platforms, internet portals and internet sales platforms.

A method for the manufacture of printed goods presentations in the form of catalogs, brochures and the like, comprising provision of layout information, provision of a processing module which, according to the layout information, automatically compiles a print template using the goods for presentation in the printed goods presentation, wherein the processing module retrieves the goods data from a database of goods data for generating online publications.

A method as set forth in the previous paragraph, characterized by the fact that the database of goods data comprises goods information for managing inventory and data for describing goods.

A method as set forth in the previous two paragraphs, characterized by the fact that the goods information for managing inventory is taken over from a database of goods information used for managing inventory, and/or the data for describing goods in a database used for internet publications are also taken over into the database of goods data or are incorporated in this by reference.

A method as set forth in the previous three paragraphs, characterized by the fact that the database of goods data is a database having a self-contained data structure or comprises several sub-databases.

A method as set forth in the previous nine paragraphs, characterized by the fact that the layout information is stored in a database.

A method as set forth in the previous ten paragraphs, characterized by the fact that the database of layout information is integrated into the database of goods data.

A method as set forth in the previous eleven paragraphs, characterized by the fact that the database of layout information contains data from the group comprising information about text size, text position, image size, image position, font, font color, background color, frame layout, page size, number of pages and pagination.

A method as set forth in the previous twelve paragraphs, characterized by the fact that the processing module, in line with the layout information, provides a layout framework, which is populated with goods data.

A method as set forth in the previous thirteen paragraphs, characterized by the fact that the processing module provides an input unit, with which a selection can be made as to which goods or groups of goods are to be included in the printed goods presentation and/or when and in which cycles the printed goods presentation is automatically created and/or which layout templates are used and/or for which language, country, target audience, customers of an online shop, interne auction platform, internet portal or internet sales platform the printed presentation is made.

A method as set forth in the previous paragraph, characterized by the fact that the processing module groups several goods together to form goods groups on the basis of predetermined criteria.

A method as set forth in the previous fifteen paragraphs, characterized by the fact that the print template is provided as a data file that can be processed by a printing device.

A method as set forth in the previous paragraph, characterized by the fact that the print file is made available as a PDF (portable document format) file.

A method as set forth in the previous seventeen paragraphs, characterized by the fact that the processing module automatically sends the print template to a printing device, such that the printing process starts automatically.

A method as set forth in the previous eighteen paragraphs, characterized by the fact that the print template for each printed goods presentation comprises address information, such that, after the printed goods presentation has been printed, it is shipped in accordance with the address information.

A method as set forth in the previous nineteen paragraphs, characterized by the fact that the print template is created in accordance with predetermined criteria, such that it is customized for each addressee or a group of addressees.

A method as set forth in the previous twenty paragraphs, characterized by the fact that the print template is sent electronically as a print file to the addressee direct.

A method as set forth in the previous twenty-one paragraphs, characterized by the fact that the goods information has data from the group comprising goods numbers, number of goods, storage location, price, weight, dimensions, combinations with other goods and the like.

A method as set forth in the previous twenty-two paragraphs, characterized by the fact that the data for describing the goods have data from the group comprising images, descriptions and the like.

A method as set forth in the previous twenty-three paragraphs, characterized by the fact that the print template for the printed goods presentation comprises goods information and/or data for describing the goods.

A method as set forth in the previous twenty-four paragraphs, characterized by the fact that the processing module is provided as a software product in the form of command sequences for execution on a data-processing system, said sequences being stored in binary form or provided via data lines.

A device for automated processing of goods data for sales purposes, comprising a data-processing system with access to a database of goods data comprising goods information for managing inventory and data for describing goods, and a processing module realized by means of software on a data-processing system, said processing module preparing the goods data for publication, characterized by the fact that a database of layout information is provided, such that the processing module, on request, can automatically create a print template for a printed goods presentation from the goods data.

A device as set forth in the previous paragraph, characterized by the fact that the goods information for managing inventory is taken over from a database of goods information and/or data for describing goods are taken over into the database of goods data or are incorporated into this by reference.

A device as set forth in the previous two paragraphs, characterized by the fact that the database of goods data is a database having a self-contained data structure or comprises several sub-databases.

A device as set forth in the previous three paragraphs, characterized by the fact that an existing database of goods information for managing inventory is used, which is managed and/or shared by other data-processing systems and/or data-processing programs, and/or the data for describing goods, which are managed and/or shared by other systems, are used.

A device as set forth in the previous four paragraphs, characterized by the fact that the processing module can automatically prepare and/or provide the goods data additionally for the purpose of publication in at least one of the groups comprising online shops, internet auction platforms, internet portals and internet sales platforms.

A device for the manufacture of printed goods presentations in the form of catalogs, brochures and the like, comprising a data-processing system having a database of layout information and a processing module realized by means of software on the data-processing system, said processing module being configured such that, in line with the layout information, it can automatically compile a print template of the goods for presentation in the printed goods presentation, with the processing module having an interface which enables it to retrieve goods data from a database of goods data used for generating online publications, from the same or a different data-processing system.

A device as set forth in the previous paragraph, characterized by the fact that the database of goods data comprises goods information for managing inventory and data for describing goods.

A device as set forth in the previous two paragraphs, characterized by the fact that the goods information for managing inventory is taken over from a database of goods information used for managing inventory, and/or the data for describing goods in a database used for internet publications are also taken over into the database of goods data or are incorporated in this by reference.

A device as set forth in the previous three paragraphs, characterized by the fact that the database of goods data is a database having a self-contained data structure or comprises several sub-databases.

A device as set forth in the previous four paragraphs, characterized by the fact that the layout information is stored in a database.

A device as set forth in the previous nine paragraphs, characterized by the fact that the database of layout information is integrated into the database of goods data.

A device as set forth in the previous ten paragraphs, characterized by the fact that the database of layout information contains data from the group comprising information about text size, text position, image size, image position, font, font color, background color, frame layout, page size, number of pages and pagination.

A device as set forth in the previous eleven paragraphs, characterized by the fact that the processing module provides an input unit, with which a selection can be made as to which goods or groups of goods are to be included in the printed goods presentation and/or when and in which cycles the printed goods presentation is automatically created and/or which layout templates are used.

A device as set forth in the previous paragraph, characterized by the fact that the processing module can group several goods together to form goods groups on the basis of predetermined criteria.

A device as set forth in the previous thirteen paragraphs, characterized by the fact that the print template is provided as a data file that can be processed by a printing device.

A device as set forth in the previous paragraph, characterized by the fact that the print file is made available as a PDF (portable document format) file.

A device as set forth in the previous fifteen paragraphs, characterized by the fact that the data-processing system has a communications device, such that the processing module can automatically send the print template to a printing device, such that the printing process is started automatically.

A device as set forth in the previous sixteen paragraphs, characterized by the fact that the print template for each printed goods presentation comprises address information, such that, after the printed goods presentation has been printed, it can be shipped in accordance with the address information.

A device as set forth in the previous seventeen paragraphs, characterized by the fact that the goods information has data from the group comprising goods numbers, number of goods, storage location, price, weight, dimensions, combinations with other goods and the like.

A device as set forth in the previous eighteen paragraphs, characterized by the fact that the data for describing the goods have data from the group comprising images, descriptions and the like.

A device as set forth in the previous nineteen paragraphs, characterized by the fact that the print template for the printed goods presentation comprises goods information and/or data for describing the goods.

A database for managing inventory having a plurality of data on a multiplicity of different goods, wherein the database data comprise goods information for managing inventory and data for describing products, characterized by the fact that the database furthermore comprises layout information for a print template for a printed goods presentation of the goods.

A database as set forth in the previous paragraph, characterized by the fact that the goods information has data from the group comprising goods numbers, number of goods, storage location, price, weight, dimensions, combinations with other goods and the like.

A database as set forth in the previous two paragraphs, characterized by the fact that the data for describing the goods have data from the group comprising images, descriptions and the like.

A software product for automated processing of goods data for sales purposes for the purpose of implementing the methods above.

A software product for the manufacture of printed goods presentations in the form of catalogs, brochures and the like by the methods above.

The invention claimed is:

1. A method for the automated processing of goods data for sales purposes comprising:
providing of a database of goods data comprising goods information for managing inventory and/or data for describing goods;
providing a processing module which prepares the goods data for publication;
providing a database of layout information; and
automatically using the goods data with the processing module to create a print template for a printed goods presentation on request.

2. The method in accordance with claim 1, further including:
automatically preparing or providing the goods data with the processing module for publication in at least one of the groups comprising online shops, internet auction platforms, internet portals and internet sales platforms.

3. The method in accordance with claim 1, further including:
integrating the database of layout information into the database of goods data.

4. The method in accordance with claim 1, further including:
providing a layout framework which is populated with goods data with the processing module in line with the layout information.

5. The method in accordance with claim 1, further including:
providing an input unit for the processing module, with which a selection can be made as to which goods or groups of goods are to be included in the printed goods presentation and/or when and in which cycles the printed goods presentation is automatically created and/or which layout templates are used and/or for which language, country, target audience, customers of an online shop, internet auction platform, internet portal or internet sales platform the printed presentation is made.

6. The method in accordance with claim 1, further including:
providing the print template as a data file that can be processed by a printing device.

7. The method in accordance with claim 1, further including:
automatically sending the print template to a printing device with the processing module, such that the printing process starts automatically.

8. The method in accordance with claim 1, further including:
the processing module is provided as a software product in the form of command sequences for execution on a data-processing system, the sequences being stored in binary form or provided via data lines.

9. A method for the manufacture of printed goods presentations comprising;
providing layout information;
providing a processing module which, according to the layout information, automatically compiles a print template using the goods for presentation in the printed goods presentation, wherein the processing module retrieves the goods data from a database of goods data for generating online publications.

10. The method in accordance with claim 9, wherein:
the layout information is provided in a database.

11. The method in accordance with claim 9, further including:
automatically preparing or providing the goods data with the processing module for publication in at least one of the group comprising online shops, internet auction platforms, internet portals and internet sales platforms.

12. The method in accordance with claim 9, further including:
integrating the database of layout information into the database of goods data.

13. The method in accordance with claim 9, further including:
providing a layout framework which is populated with goods data with the processing module in line with the layout information.

14. The method in accordance with claim 9, further including:
providing an input unit for the processing module, with which a selection can be made as to which goods or groups of goods are to be included in the printed goods presentation and/or when and in which cycles the printed goods presentation is automatically created and/or which layout templates are used and/or for which language, country, target audience, customers of an online shop, internet auction platform, internet portal or internet sales platform the printed presentation is made.

15. The method in accordance with claim 9, further including:
providing the print template as a data file that can be processed by a printing device.

16. The method in accordance with claim 9, further including:
automatically sending the print template to a printing device with the processing module, such that the printing process starts automatically.

17. The method in accordance with claim 9, further including:
the processing module is provided as a software product in the form of command sequences for execution on a data-processing system, the sequences being stored in binary form or provided via data lines.

18. A device for automated processing of goods data for sales purposes comprising:
a data-processing system with access to a database of goods data comprising goods information for managing inventory and data for describing goods;
a processing module comprising software, the processing module preparing the goods data for publication; and
a database of layout information;
wherein the processing module, on request, can automatically create a print template for a printed goods presentation from the goods data using the database of layout information.

19. A device for the manufacture of printed goods presentations comprising:
a data-processing system having a database of layout information;
a processing module comprising software, the processing module being configured such that, in line with the layout information, the processing module can automatically compile a print template of the goods for presentation in the printed goods presentation, with the processing module having an interface which enables the processing module to retrieve goods data from a database of goods data used for generating online publications, from the same or a different data-processing system.

20. A database for managing inventory having a plurality of data on a multiplicity of different goods, wherein the database data comprises:
goods information for managing inventory and data for describing products; and
layout information for a print template for a printed goods presentation of the goods.

21. A software product for automated processing of goods data for sales purposes for the purpose of implementing the method for the automated processing of goods data for sales purposes comprising:
a database of goods data comprising goods information for managing inventory and/or data for describing goods;
a processing module which prepares the goods data for publication; and
a database of layout information, such that, on request, the processing module automatically uses the goods data to create a print template for a printed goods presentation.

22. A software product for the manufacture of printed goods presentations by a method for the manufacture of printed goods presentations comprising:
layout information;
a processing module which, according to the layout information, automatically compiles a print template using the goods for presentation in the printed goods presentation, wherein the processing module retrieves the goods data from a database of goods data for generating online publications.
